(19) United States
(12) Patent Application Publication
(10) Pub. No.: US 2025/0207998 A1
(43) Pub. Date: Jun. 26, 2025

(54) ON-SILICON INTEGRATED TEST STRUCTURE FOR THE CHARACTERIZATION OF THE PDL OF A FIBER/SILICON OPTICAL COUPLER WITH A TWO-DIMENSIONAL DIFFRACTION GRATING

(71) Applicant: Commissariat à l'Energie Atomique et aux Energies Alternatives, Paris (FR)

(72) Inventors: Daivid FOWLER, Grenoble Cedex 09 (FR); Leopold VIROT, Grenoble Cedex 09 (FR); Philippe GROSSE, Grenoble Cedex 09 (FR)

(73) Assignee: Commissariat à l'Energie Atomique et aux Energies Alternatives, Paris (FR)

(21) Appl. No.: 19/002,634

(22) Filed: Dec. 26, 2024

(30) Foreign Application Priority Data
Dec. 26, 2023 (FR) FR2315259

(51) Int. Cl. G01M 11/00

(52) U.S. Cl. CPC G01M 11/337

(57) ABSTRACT

An on-silicon integrated test structure for characterizing the PDL of a “1 to 2” fiber/silicon optical coupler with a two-dimensional diffraction grating (2DGC), includes the 2DGC to be tested configured as an output coupler, mirrored with another “1 to 2” fiber/silicon optical coupler configured as an input coupler, via planar waveguides coupling their respective guided optical terminals. An adjustable phase shifter is arranged at one of these waveguides. A p- or s-polarized optical signal is input via the input coupler. The adjustable phase shifter is controlled to apply a pure phase shift between 0 and π to the optical signal propagating in this waveguide. The optical signal input to the 2DGC under test then sweeps through all the mixed polarization states. The variation in optical transmission in the 2DGC under test during this sweep gives the PDL.

### TECHNICAL FIELD OF THE INVENTION

The present invention relates generally to photonic integrated circuits (PICs) designed to be coupled to one or more optical fibers, and more particularly to an optical coupler with a diffraction grating for achieving optical coupling between the optical fiber(s) and such a photonic integrated circuit.

The invention has applications, in particular, in the field of optical telecommunications and data transmission networks on single- or multi-mode optical fibers, e.g. for high-speed links in passive optical networks (PONs) such as Fiber-to-the-Home (FTTH) networks.

### TECHNOLOGICAL BACKGROUND

Fiber optic transmission systems use data links in which each fiber link comprises a transmitter at one end of a fiber and a receiver at the other end of said fiber. Because fiber optics are relatively inexpensive, most systems operate on a full-duplex basis, transmitting in one direction on one fiber and in the opposite direction on another. Some systems, however, such as FTTH passive optical networks (PON), use bidirectional transmission over a single fiber, using transmitter-receiver components called “transceivers” that include an optical coupling device, or grating optical coupler (or simply “grating”).

The invention is particularly concerned with optical couplers used to achieve optical coupling between optical fiber(s) and photonic circuits, when the grating optical coupler is integrated with the photonic circuits on the same substrate, for example a silicon (Si) substrate. More specifically, the type of coupler in question is a two-dimensional grating coupler, often referred to as either a 2DGC (two-dimensional grating coupler) or a PSGC (polarization splitting grating coupler). A 2DGC is a polarization-diversity fiber coupler. This component is typically (but not exclusively) used in a transceiver, in the receiving circuit where light arrives via an optical fiber with an arbitrary polarization state (which can vary as a function of time), and must be coupled to the photonic circuit's waveguides (made using semiconductor circuit manufacturing technologies, for example on a silicon substrate).

The ability of an optical fiber system to transmit data correctly is generally assessed by the bit error rate (BER) of the transmitted binary information. BER is the inverse of SNR (Signal-to-Noise Ratio): for example, a high BER means a low SNR, and vice versa. BER ultimately depends on the optical power of the optical signal received at the receiver. Too much or too little received optical power will both result in high bit error rates. This is because, in the first case, the receiver amplifier becomes saturated, and in the second case, noise becomes a problem because it interferes with the useful signal.

Optical power at the receiver depends on two fundamental factors: how much power is sent into the fiber by the transmitter, and how much is lost through attenuation in the fiber optic cable(s) installation that connects the transmitter to the receiver. For this reason, all manufacturers of data link components must specify the receiver sensitivity of their components and the minimum power coupled into the fiber from the source (this may be a minimum power requirement), which every data link system designer or manufacturer needs to know, as well as the test conditions. For data link components, these include data input frequency or input bit rate and duty cycle, supply voltages, and the type of fiber coupled to the source.

In summary, for both the development and operational deployment of a transceiver model, it is important to accurately characterize insertion loss (IL, from “Insertion Loss”) as well as the variation of insertion loss as a function of incident polarization (PDL, from “Polarization Dependent Loss”).

The present invention provides a test device that enables the IL and PDL of a 2DGC coupler to be characterized more conveniently and accurately than known methods.

The most common method for measuring the PDL of an optical component is to measure its transmission as a function of time, scanning all polarization states. This method, applied to a 2DGC, is the one used in the scientific paper by F. Van Laere et al, “Efficient Polarization Diversity Grating Couplers in Bonded InP-Membrane” IEEE Photonics Technol. Lett. vol. 20, no. 4, pp. 318-320, February 2008, doi: 10.1109/LPT.2007.915587. It has the advantage that at no time is it necessary to know the state of incident polarization on the device under test. In the case of a 2DGC, it is the sum of the intensity of the two outputs that must be considered. The test structure typically consists of a 2DGC as input, and either an identical 2DGC or any other type of fiber coupler, or photodiodes integrated within the photonic circuit as output. Although simple in principle, this method has a number of drawbacks in practice. These include:
polarization must be swept for each wavelength point. Sweeping a spectrum (typically between 10 and 10,000 wavelength points) of IL and PDL can take minutes per component, which is not compatible with high-volume testing; and,
it must be ensured that the power injected does not vary according to the state of polarization and to wavelength.

A second characterization method is known from the scientific paper by Mekis et al, “A Grating-Coupler-Enabled CMOS Photonics Platform” IEEE J. Sel. Top. Quantum Electron, vol. 17, no. 3, pp. 597-608, May 2011, doi: 10.1109/JSTQE.2010.2086049. This depends on the symmetry of the component, which means that incident light can be considered as a linear superposition of s-polarized light (electric field perpendicular to the plane of incidence) and p-polarized light (electric field parallel to the plane of incidence). These two polarization states represent two extreme cases, which for each wavelength determine the total range of transmission values as a function of polarization (namely the PDL). Thus, the PDL of the component can be evaluated by measuring two transmission spectra, for the incident polarizations s and p, respectively. In principle, this method solves the problem of measurement time. However, as with the first method, the accuracy with which the PDL can be evaluated depends on the equality of the power of the injected light in p and s, as well as the degree of purity of the incident polarization. In practice, it is difficult to set up a polarization switch that is satisfactory in this respect.

US20120207428A1 discloses a photonic integrated circuit for processing a light beam which comprises a first 2DGC-type coupler for coupling the light beam, a second 2DGC-type coupler for coupling the light beam and a waveguide structure having two separate waveguide arms for splitting the light beam received from the first coupler and recombining the light beam in the second coupler. The light beam is coupled into and out of the circuit by optical fibers positioned on the couplers. A phase shifting device is further provided to generate a further phase shift in at least one of the two separate waveguide arms, thereby producing a relative phase shift of π between the two separate waveguide arms so as to provide a TE/TM polarization switch for the radiation between the first coupler and the second coupler. The circuit thus disclosed is a polarization diversity circuit in which optical processing can be performed, by photonic processors arranged in each of the waveguide arms, respectively. The phase shift π introduced by the phase shifter arranged in one of the waveguide arms switches each input polarization to the crossed polarization, so that the optical processing that is performed between the two couplers, each for a portion of the incident light, becomes PDL-independent after recombination in the output coupler, since any PDL incidence in one arm is compensated by an inverse incidence in the other arm. In other words, the circuit eliminates the effect of PDLs in the input coupler by splitting the radiation received at said input coupler into two components and symmetrizing them (in terms of polarization) by means of the phase shifter present in one arm, which introduces a single, fixed phase shift, equal to, between the radiation components processed in the two waveguide arms by the integrated photonic circuits, respectively, prior to their recombination in the output coupler. This circuit is not suitable for use as a test circuit for characterizing the PDLs of the output coupler.

The article by Robert HALIR et al. “Reducing Polarization-Dependent Loss of Silicon-on-Insulator Fiber to Chip Grating Couplers”, IEEE PHOTONICS TECHNOLOGY LETTERS, IEEE, USA, vol. 22, no. 6, Mar. 15, 2010 (2010-03-15), pages 389-391, ISSN: 1041-1135, DOI: 10.1109/LPT.2009.2039869 is a scientific paper, some of whose authors are cited as inventors in patent application US20120207428A1 identified and discussed above. It discloses substantially the same technical teaching.

The article by Zanyun ZHANG et al. entitled “High-Efficiency Two-Dimensional Perfectly Vertical Grating Coupler With Ultra-Low Polarization Dependent Loss and Large Fibre Misalignment Tolerance”, IEEE JOURNAL OF QUANTUM ELECTRONICS, IEEE, USA, vol. 57, no. 5, Jul. 7, 2021 (2021-07-07), pages 1-7, ISSN: 0018-9197, DOI: 10.1109/JQE.2021.3095289 is related to 2DGC four-port, i.e. a 1×4 coupler (power divider/mixer) for optical modulation. The performance of this coupler is tested in a configuration comprising two such 2DGC couplers placed back-to-back and connected by waveguide arms in which phase shifters are present, enabling phase equalization between the different arms.

The article by Zanyun ZHANG et al, entitled “Two-Dimensional Apodized Grating Coupler for Polarization-Independent and Surface-Normal Optical Coupling”, JOURNAL OF LIGHTWAVE TECHNOLOGY, IEEE, USA, vol. 38, no. 15, Apr. 8, 2020 (2020-04-08), pages 4037-4044, ISSN: 0733-8724, DOI: 10.1109/JLT.2020.2986043 has several authors in common with the article by Zanyun ZHANG et al., 2021, identified and discussed above. Having been published a year earlier, it reports the work of the same team of researchers at an earlier stage. The subject of this work, and therefore the technical teaching disclosed, is substantially the same. In this earlier paper, the envisaged application examples of the 1×4 coupler were a polarimeter and a polarization-independent on-chip photonic receiver, whereas the paper by Zanyun ZHANG et al., 2021 mentions an optical power modulator (mixer).

### SUMMARY OF THE INVENTION

The aim of the invention is to provide an alternative to the above-mentioned test methods, which alleviates some or all of the above-mentioned disadvantages.

This goal is achieved, according to a first aspect of the invention, by means of an on-silicon integrated test structure for the characterization of the polarization-dependent loss, PDL, of a “1-to-2” fiber/silicon optical coupler with a two-dimensional diffraction grating, 2DGC, having a fibered optical terminal as well as a first guided optical terminal and a second guided optical terminal, said test structure comprising:
a first planar waveguide with two ends;
a second planar waveguide with two ends;
an input fiber/silicon optical coupler having a fiber optic terminal, adapted to receive an input optical signal via said fiber optic terminal, and associated optical splitting means which are adapted to split said input optical signal into two components of equal respective optical intensities, and which are arranged to insert each of said components into the first planar waveguide and into the second planar waveguide, respectively, at a respective first end of said planar waveguides; and,
the 2DGC under test, arranged as an output fiber/silicon optical coupler with its two guided optical terminals coupled to a second end of the first planar waveguide and the second planar waveguide, respectively, and configured to deliver an optical output signal on its fibered optical terminal.

The test structure further comprises:
at least a first adjustable phase shifter which is arranged at the level of the first planar waveguide between the input optical coupler and the 2DGC under test, and which is configured to be driven so as to apply a phase shift determined between 0 and I, as a function of a phase shift adjustment signal, to the optical signal propagating in said first planar waveguide, said phase shift being a pure phase shift, i.e. without optical intensity variation.

The invention exploits the fact that the intensity of light propagating in respective planar waveguides at each of the 2DGC outputs is identical when exciting the input coupling grating with purely p-polarized or purely s-polarized light, but with a phase shift of propagation in the two guides that is either 0° or 180° (values 0 and π, respectively, in radians) for an excitation electric field E polarized entirely in s and entirely in p, respectively, and above all on the observation that this relationship between output phase and input polarization is a continuous and reciprocal one.

Some preferred but non-limiting aspects of this device are as follows.

In embodiments, the input optical coupler and its associated optical splitting means may comprise a 1-to-1 fiber/silicon optical coupler followed by an optical power splitter with one input and two outputs and with equal optical power splitting between said outputs, said outputs each being coupled to one of the first ends of the first planar waveguide and the second planar waveguide, respectively.

For example, the 1-to-1 fiber/silicon coupler can be a one-dimensional diffraction grating coupler (1DGC).

In other embodiments, the input optical coupler and its associated optical splitting means may comprise a second 2DGC, identical to the 2DGC under test, and having its guided optical terminals each coupled to the other of the ends of the first planar waveguide and the second planar waveguide, respectively.

In embodiments, the test structure further comprises a second adjustable phase shifter, structurally identical to the first adjustable phase shifter, which is arranged at the level of the second planar waveguide between the input optical coupler and the 2DGC under test, and which is configured such that it permanently applies no phase shift to the optical signal propagating in said second waveguide.

In embodiments, the optical coupler under test and the input optical coupler can be arranged symmetrically with respect to each other, such that an input optical fiber can be connected to the fibered optical terminal of the input optical coupler and an output optical fiber can be connected to the fibered optical terminal of the optical coupler under test, with said input optical fiber and said output optical fiber extending opposite each other.

In other embodiments, the optical coupler under test and the input optical coupler are arranged as a block in such a way that an input optical fiber can be connected to the fibered optical terminal of the input optical coupler and an output optical fiber can be connected to the fibered optical terminal of the optical coupler under test, said input optical fiber and said output optical fiber being optical fibers of the same fiber array.

The first adjustable phase modulator can advantageously be a thermo-optical phase shifter.

A second aspect of the invention relates to a test equipment for the characterization of the polarization-dependent loss, PDL, of a “1-to-2” fiber/silicon optical coupler with two-dimensional diffraction grating, 2DGC, comprising:
an on-silicon integrated test structure according to the first aspect above, with the 2DGC coupler under test arranged as the output fiber/silicon optical coupler of said test structure;
a test controller,
a source of polarized light, configured to produce an incident optical signal being either fully p-polarized or fully s-polarized, and
a light sensor arranged to measure the optical transmission at the output of the optical coupler under test, which is the optical power transmitted by the test structure from the light power fed in at the input coupler of said test structure,
   wherein the test controller comprises a computer and a memory comprising random access memory, and is configured to:
cause an optical input signal to be inserted into the fibered optical terminal of the test structure's input optical coupler;
drive the adjustable phase shifter of the test structure by varying a phase shift adjustment signal of said phase shifter so that the phase shift applied to the optical signal propagating in the first planar waveguide of said test structure sweeps the interval [0;π]; and at the same time,
cause the light sensor to measure, and the memory to store values of the optical power transmitted through the test structure as a function of the value of the phase shift,
determine the maximum value and the minimum value of the measured and stored values of the transmitted optical power; and.
obtain the PDL as the difference between said maximum optical transmission value and said minimum optical transmission value.

In one embodiment of the equipment, the polarized light source and/or light sensor can be formed on the same silicon substrate, or wafer, on which the test structure is formed.

In a third aspect, the invention also relates to a method of characterizing the polarization-dependent loss, PDL, of a “1-to-2” fiber/silicon optical coupler with two-dimensional diffraction grating, 2DGC, using a silicon-integrated test structure according to the first aspect above, said method comprising the following steps:
inserting an optical input signal into the fibered optical terminal of the optical input coupler;
measuring and recording values of the optical power transmitted through the test structure as a function of the value of the phase shift applied to the optical signal propagating in the first planar waveguide by the adjustable phase shifter, while the phase shift control signal of said phase shifter is varied so that said phase shift sweeps the interval [0;π];
determining the maximum value and the minimum value of the measured and recorded values of the transmitted optical power; and,
obtaining the PDL as the difference between said maximum value and said minimum value.

A fourth and final aspect of the invention relates to a computer program product comprising one or more sequences of instructions stored on a memory medium readable by a machine comprising a processor, said sequences of instructions being adapted to perform all the steps of the method according to the third aspect of the invention when the program is read from the memory medium and executed by the processor.

### PRESENTATION OF DRAWINGS

Further features and advantages of the invention will become apparent from the following description. It is purely illustrative and should be read in conjunction with the appended drawings in which:

FIG. 1 is a schematic representation of a use case for 2DGC couplers for optical data transmission over an optical fiber;

FIG. 2 is a simplified isometric perspective diagram of an example of a 2DGC coupler;

FIG. 3 shows simplified schematic representations of three conventional test structures for measuring the PDL of a 2DGC;

FIG. 4 is an illustration of the method for measuring the PDL of a 2DGC with a conventional test structure as shown in FIG. 3;

FIG. 5A and FIG. 5B illustrate the reciprocal relationship between the polarization of the input light and the phase shift between the two outputs of a 2DGC fiber/silicon coupler;

FIG. 6A and FIG. 6B are simplified diagrams of two variants of the proposed test structure, suitable for use with separate input and output fibers;

FIG. 7A and FIG. 7B are simplified diagrams of two variants of the test structures of FIG. 6A and FIG. 6B, respectively, suitable for use with input and output fibers that are arranged in a unitary block (so-called “fiber array”);

FIG. 8A and FIG. 8B are schematic and functional representations illustrating the method of measuring the PDL of a 2DGC with the proposed test structure, and with test equipment suitable for implementing the method;

FIG. 9 is a simplified diagram of another variant of the test structure with an input optical power splitter; and,

FIG. 10 is a step diagram illustrating the implementation of the method steps according to embodiments of the proposed method.

### DESCRIPTION OF EMBODIMENTS

In the following description of embodiments and in the figures of the attached drawings, same or similar elements bear the same reference signs.

In the field of wave (or vibratory) physics, the electromagnetic wave is a model used to study electromagnetic radiation. It should be distinguished between electromagnetic radiation, which is the phenomenon under study, and the electromagnetic wave, which is one of the representations of the phenomenon. Another representation, namely the corpuscular (or quantum) representation, takes into account the existence of the photon, and is not considered here.

Like all waves, an electromagnetic wave can be studied using spectral analysis, i.e. a wave with a certain spectral width (i.e. a frequency spectrum comprising several distinct wavelengths) can be broken down into a sum of waves, each with a single specific wavelength, known as “monochromatic” waves. Light is thus made up of electromagnetic waves, i.e. vibrations at one or more wavelengths in the visible frequency spectrum, i.e. approximately between wavelengths of 400 and 800 nm.

Physically speaking, an electromagnetic wave is a field, i.e. an area of space whose properties are modified. Each point in space is assigned a physical vector quantity, i.e. a vector that represents not only the amplitude of the field concerned, but also its orientation in space. This orientation is represented, for each vibration at a given wavelength, by the orientation of the associated vector relative to a referential {X, Y,Z}, commonly the terrestrial reference frame linked to the Earth's surface. Light waves are vector waves, i.e. waves that can oscillate in more than one orientation.

An electromagnetic wave represents the propagation of an electric field and an associated magnetic field, perpendicular to each other and to the direction of wave propagation. Like all propagating electromagnetic waves, in fact, a light wave is defined by the local perturbation of the electric field (commonly noted as “E”, this letter being surmounted by an arrow to designate more specifically the vector associated with said field: \vec{E}) and of the magnetic field (commonly noted as “B”, this letter being surmounted by an arrow to designate the vector associated with said field: \vec{B}). The disturbance is initially produced by charged particles that are accelerated, but it can also propagate through a propagation medium that may be devoid of particles (such as the vacuum of space). In the case of a plane wave, which is a good approximation for most light waves, each of the vectors \vec{E} and \vec{B} oscillates in one and the same respective plane, which planes are both perpendicular to the rectilinear propagation direction (commonly represented by a vector \vec{V} in the terrestrial referential {X,Y,Z} as well). In the study of electromagnetic waves, and in particular light, it is customary to ignore the magnetic field \vec{B}, as its variations can be determined from those of the electric field \vec{E}, which are linked to them through Maxwell's equations. We will therefore consider only the electric field \vec{E} in what follows.

Polarization is the property of vector waves that they exhibit a preferred distribution of the spatial orientation of their constituent vibrations. Sound waves, for example, do not have this property because they are longitudinal waves: they propagate via air molecules that collide with neighboring air molecules, the local movement of these molecules being in the same direction as the propagation of energy. Conversely, light waves have polarization properties, as the orientation of the electric field \vec{E} is transverse to that of the wave propagation. In concrete terms, the polarization of light corresponds to the direction of the electric field E.

Polarization is rectilinear when \vec{E} is always oriented in the same direction. By convention, rectilinear polarization is said to be vertical (vertical polarization) when the electric field vector \vec{E} is vertical with respect to the {X, Y,Z} referential. Similarly, rectilinear polarization is said to be horizontal (horizontal polarization) when the electric field vector \vec{E} is horizontal with respect to the {X, Y,Z} referential. In both cases, the vector \vec{E} is perpendicular to the direction of propagation \vec{V}. For an unpolarized wave, or natural wave, the vector \vec{E} rotates around its axis in an arbitrary and unpredictable way over time. Polarizing a light wave means giving a defined trajectory to the electric field E. Once given, the polarization of a light wave can be maintained or modified, depending on the conditions of wave propagation.

Various phenomena affect the wave-like behavior of light as it propagates. In a homogeneous, isotropic medium (i.e. one whose physical properties are invariant to direction), the electromagnetic wave propagates in a straight line. On the other hand, when it encounters an obstacle, diffraction occurs (i.e., scattering of the wave by various points on the object, manifested by interference phenomena, i.e. combinations of two induced waves that are of the same frequency but have phase shifts between them). In addition, when the propagation medium changes, there is reflection (part of the electromagnetic wave returns to the original medium) and refraction (another part of the wave propagates through the second medium, but in a different direction). Refraction also occurs if the properties of the propagation medium change according to location (heterogeneity).

The reflection of light on certain materials transforms its polarization. To understand and account for this, one breaks down the polarization of light into two mutually orthogonal rectilinear polarizations, denoted s and p. The s polarization is the component of the electric field that is perpendicular to the plane of incidence of the wave, and the p polarization is the component of the electric field that is contained in this plane. Light is reflected to a greater or lesser extent depending on whether it is s- or p-polarized, and on the angle of incidence (i.e. the angle between the direction of propagation of the incident wave and the direction normal to the plane of the reflective interface considered to be locally flat).

The increase in data transmission rates over optical communication networks and the use of wavelength division multiplexing (WDM) means that systems are all the more sensitive to the phenomena mentioned above, such as chromatic dispersion and polarization. Generally speaking, this means that the characteristics of the optical components making up the network need to be monitored right from the design phase, and to be taken into account when improving and designing these components. This concerns in particular the characteristics of optical couplers in integrated circuits built on silicon (or other) substrates at the interface between the optical fiber and one (or more) waveguide(s) formed on a silicon wafer using silicon-based microelectronics technologies.

Polarization-dependent losses (PDL) are defined as the maximum variation in the optical power transmitted by an optronic component or other optical device, when the input polarization state (or SOP, standing for “State of Polarization”) is modified over all possible polarization states.

Fiber arrays (or optical fiber arrays or fiber array units) are one- or two-dimensional arrays of optical fibers. Often, such an array is formed only at the end of a bundle of fibers, rather than along the entire length of the fiber. The purpose of such an array is usually to couple light from an array of sources to the fibers, or from the fibers to another component, such as a planar waveguide array on a photonic integrated circuit.

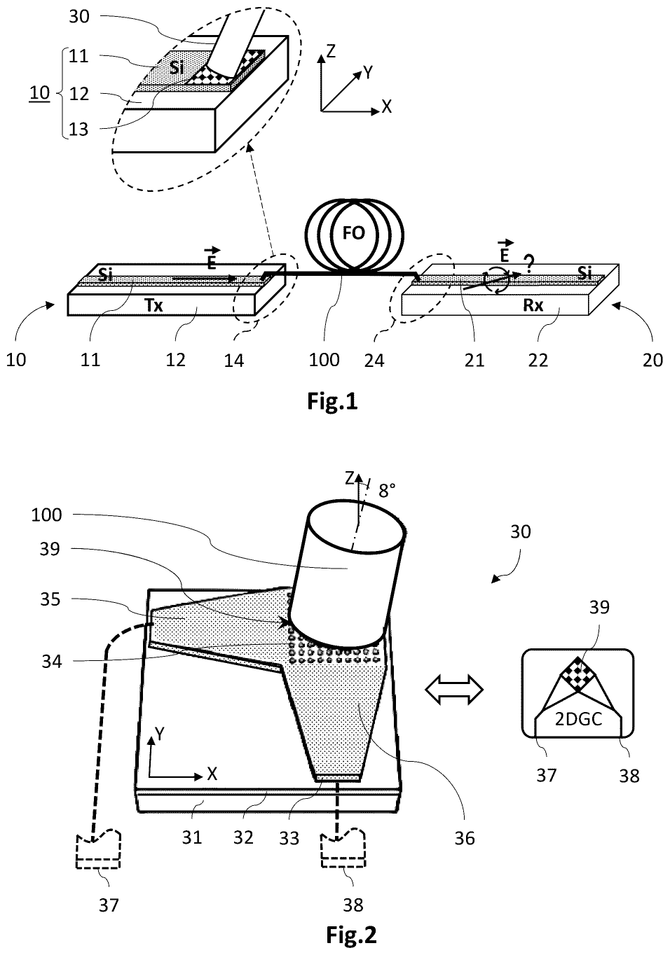

The simplified diagram in FIG. 1 illustrates the use of such integrated optical couplers, namely a transmit (Tx) coupler 10 and a receive (Rx) coupler 20.

For the rest of the description, we define an orthogonal three-dimensional direct referential {X, Y,Z}, where the X and Y axes form a plane parallel to the main plane of the wafer forming the planar substrate, and where the Z axis is oriented substantially orthogonal to the main plane of the wafer, this Z axis being oriented in the direction of the axis of gravity. In the remainder of the description, the terms “vertical” and “vertically” are understood to refer to an orientation substantially parallel to the Z axis, and the terms “horizontal” and “horizontally” to refer to an orientation substantially parallel to the (X,Y) plane. Furthermore, the terms “top” and “bottom” and their derivatives (such as “above” and “below”, or “over” and “under”), as well as the terms “bottom” and “top”, used to qualify an element of the microstructure under consideration, are understood to relate to an increasing positioning away from the wafer towards the top, i.e., along the +Z vertical direction.

Each of the couplers 10 and 20 comprises a waveguide 11 or 21, respectively, made of silicon on a doped silicon substrate 12 or 22, respectively. It also comprises a coupling grating (i.e. a diffraction grating), made for example by a layer of silicon (Si) with etched patterns, on a layer of silicon dioxide (SiO2), at a first end 14 or 24 of the waveguide 11 or 21, respectively. This first end of waveguide 11 or 21 of each coupler 10 and 20, respectively, is the interface for optical coupling of said coupler with a respective end of an optical fiber 100. The fiber 100, for example a Smf28™ type fiber or the like, connects the optical couplers 10 and 20 and is adapted for data transmission between said couplers. Data transmission can be unidirectional or bidirectional, monochromatic (i.e. on a single wavelength) or with multiplexing of several wavelengths (WDM). In general, the light wave is polarized at the input of the fiber 100, at the transmit coupler 10. However, the polarization of the light at the other end of the fiber, at the receive coupler 20, is variable and unstable, and therefore unknown.

In FIG. 1, a detail of the coupling zone 14 shows the coupling grating 13, providing the optical interface between the waveguide 11 of the optical coupler 10 and the relevant end of the optical fiber 100. Said grating form a lattice of holes (filled with SiO2) spaced along the X and Y directions that define a plane parallel to the surface of substrates 11 and 21, respectively, with a determined pitch. This pitch, as well as the shape of the holes, can be non-uniform across the surface of the lattice. The pitch and shape of the holes determine the behavior of the grating, and in particular the coupling characteristics in terms of wavelength and polarization. In particular, the coupling grating at the receiving coupler 20 can be insensitive to the polarization of the incoming light. In addition, and where appropriate, several coupling gratings comparable to grating 13 can be juxtaposed in the X, Y plane and/or stacked along the Z direction, each with a grating pitch distinct from that of the others to ensure multiple-wavelength coupling.

Of course, the integrated circuits that embed the optical couplers 10 and 20 may include photonic circuits designed and adapted to process the optical signal (in transmission or reception, respectively) and perform, for example, filtering, amplification, modulation or demodulation, multiplexing or demultiplexing, and so on. In addition, the data transmitted or received by the optical couplers 10 and 20, respectively, can be processed by microelectronic devices built on the same substrate as the latter and therefore included in the same integrated circuit package (“packaging” in English). Alternatively, the data can be received from or transmitted to, respectively, other integrated electronic circuits dedicated to this processing in any application-specific data processing system.

As mentioned in the introduction, some optical couplers are designed to provide both types of coupling, transmission (Tx) and reception (Rx), simultaneously for data communication via a single optical fiber. They are called “transceivers” in the jargon of the person skilled in the art, and those of interest to the embodiments of the invention are two-dimensional grating couplers, which are polarization-diversity fiber/silicon couplers known under the acronyms 2DGC or PSGC (Polarization Splitting Grating Coupler). They are generally specified for a relatively narrow range of wavelengths (a few tens of nanometers for the widest). This type of coupler is frequently used in photonics, and features a fibered terminal (i.e. coupled or capable of being coupled to an optical fiber) and two guided terminals (i.e. each coupled to a planar silicon waveguide) in a “1 by 2” structure (noted 1×2), or “Y” structure (called “T-coupler”).

An example of a 2DGC coupler is shown in FIG. 2 in a simplified isometric perspective view. The left-hand side of the figure shows schematically an example of such a coupler 30 on a substrate, while the right-hand side of the figure shows its symbolic representation as used subsequently in the other figures of the drawings.

Coupler 30 comprises a substrate 31, for example a silicon-based substrate such as a bulk silicon substrate, or a silicon-on-insulator (SOI) substrate. It then comprises an interlayer 32, e.g. a layer of silicon oxide (SiO2) deposited directly on the substrate 31, and a coupling layer 33, e.g. of silicon nitride (SiₓN_{y}), e.g. Si₃N₄. Finally, an encapsulation layer (not shown), e.g. a 1 μm-thick layer of silicon oxide (SiO2), covers the aforementioned stack of substrate 31, interlayer and coupling layer 33

The material of the coupling layer 33 deposited on the substrate 31 has a refractive index substantially higher than that of the interlayer 32 of said substrate 31, so as to ensure light guidance by total reflection. The silicon (Si) coupling layer 33 is doubly etched, using conventional integrated circuit manufacturing technologies (based on photolithography), to form an optical coupling grating 34 and planar waveguides 35 and 36.

On the one hand, the coupling layer 33 is etched at a coupling zone 34 itself, to form a two-dimensional lattice of patterns, in this case recesses or troughs (i.e. non-through holes) acting as elements of a grating. This grating constitutes the coupling network for optically coupling the coupling layer 33 to an optical fiber 100. The optical coupling interface at coupling zone 34, at which the optical fiber 100 can be coupled, thus constitutes the fiber terminal of coupler 30. In one example, the coupling layer 33 has a thickness of around 300 nm and the coupling grating patterns 34 are etched to a depth of 150 nm, for example, from the top surface of the coupling layer 33. This example is not limitative. The cross-section of these patterns in a plane orthogonal to the vertical Y direction (and therefore their shape when viewed from above) can be circular, square, pinched square, diamond-shaped, etc. The patterns are distributed in rows and columns in the X, Y plane according to a square mesh, i.e. with a periodicity of order two, and with distribution pitches along the two directions X and Y of the plane, respectively, which are identical. The skilled person will appreciate that the patterns thus etched to a depth of 150 nm are then filled with the encapsulation layer material that covers the coupling layer 33. In the example shown, the optical coupling zone 34 has a square shape when viewed from above. It can also be rectangular.

The coupling layer 33 is further etched to form two silicon-integrated planar waveguides 35 and 36, each extending from respective adjacent sides of the coupling zone 34, orthogonally to each other (i.e. forming an angle of 90° or π/2 between them). Thus, in the example shown in FIG. 2, the first waveguide 35 extends longitudinally along the X direction from a first side of the coupling zone 34 towards the left of the figure, while the second waveguide 36 extends transversely along the Y direction from a second side of the coupling zone 34, adjacent to said first side, towards the bottom of the figure. These waveguides are suitable for guiding light into the coupler 30 at the wavelength in question. Optical coupling between the fiber 100 and the waveguides 35 and 36 occurs by diffraction, with light being scattered at each of the grating elements etched into the coupling zone 34. As previously mentioned, the ends of waveguides 35 and 36 opposite the coupling zone 34 constitute the guided optical terminals of coupler 30.

These couplers operate by Y-splitting: the distribution of power in the two wire arms depends on the angle they make with the mother arm and the input polarization. So, if the two angles are equal, the power split is 50/50 for purely s and purely p polarization states. This is called a 50/50 coupler. These couplers can be reversible, in the sense that the behavior is entirely reciprocal. Indeed, an optical input signal can be inserted via the fibered optical terminal 39, and split into two components guided to the guided terminals 37 and 38, respectively. In this case, the fiber-optic terminal 39 is an input terminal and the guided optical terminals 37 and 38 are output terminals. This is referred to as a splitter coupler. But, conversely, two separate optical signals can be inserted into the coupler via the guided optical terminals 37 and 38, an optical signal resulting from the optical combination of said optical signals being output by the fibered optical terminal 39. In this case, the guided optical terminals 37 and 38 are input terminals and the fibered optical terminal 39 is an output terminal. This is referred to as a mixing coupler or “mixer”.

In silicon photonic data link receiver circuits, “1 by 2” couplers of the 2DGC type (i.e. two-dimensional grating coupler) as presented in the above, are used to efficiently couple light entering the photonic circuit with an arbitrary polarization state.

The insertion point (i.e. the point where the input optical fiber interfaces with the grating) can be represented, in horizontal cross-section viewed from above, by an oval. An oval is in fact the figure of intersection between a plane (that of the network 34) and a cylinder (that of the optical fiber 100) when the longitudinal axis of said cylinder is inclined along the Z direction normal to said plane (the inclination here being 8°, in accordance with an industry standard).

Like any real (i.e., non-ideal) passive optical component, a 2DGC coupler has insertion loss, even if very low. The insertion loss of an optical component quantifies the power lost by an optical signal as it passes through the component. If Pᵢ is the initial incoming power of the optical signal and P_{f} the final outgoing power, then the insertion loss IL is defined as, in logarithmic scale:

$$\begin{matrix}[ Math 1 ] & \\ {IL}_{dB} = 10 \times log ( \frac{{P}_{f}}{{P}_{i}} ) = 10 \times log ( T ) & Equation ( 1 )\end{matrix}$$

where T is the transmission coefficient (also called “transmission” for short), given by

$$T = \frac{{P}_{f}}{{P}_{i}} .$$

The transmission factor depends on the polarization of the light. Polarization-dependent loss is the physical quantity that quantifies this phenomenon. It is given by the difference between the maximum transmission factor Tₘₐₓ and the minimum transmission factor Tₘᵢₙ, and is defined in logarithmic scale by:

$$\begin{matrix}[ Math 2 ] & \\ {PDL}_{dB} = 10 \times log ( \frac{{T}_{max}}{{T}_{min}} ) & Equation ( 2 )\end{matrix}$$

In a 2DGC coupler, the polarization-dependent loss (PDL) is essentially due to the non-zero angle of the fiber 100, which is designed to reduce reflections at the interface between the optical fiber 100 and the silicon-etched coupling network at the coupling zone 34.

Characterizing the PDL of a 2DGC is quite critical, since PDL manifests itself as optical noise, which we do our utmost to reduce through the design of photonic structures and the choice of materials they are made of. Above all, however, it is difficult to assess under operational conditions, as IL insertion loss is easier to evaluate. In practice, the level of uncertainty is quite high for direct PDL measurements. There is also a constraint linked to the speed of evaluation, which must be high to satisfy the requirements of industrial implementation.

Characterizing the polarization-dependent loss (PDL) of a 2DGC coupler designed for use on the transmit (Tx) side of an optical transmission architecture as shown in FIG. 1 is not particularly difficult, since the polarization state of the light is known and controlled. However, this is not the case for a 2DGC coupler intended for use on the receive side (Rx), as the polarization state can vary at any time, and in an arbitrary manner.

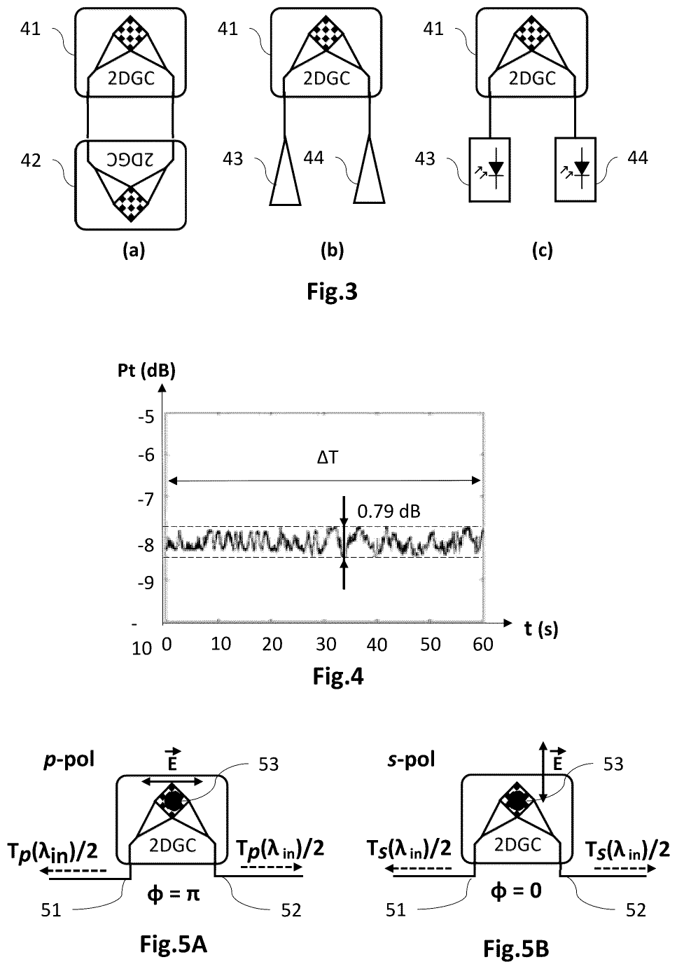

FIG. 3 shows three known examples of a 2DGC coupler test structure, which can be used to characterize the PDL of a 2DGC coupler. In these examples, a 2DGC coupler 41 is considered, whose polarization-dependent losses (PDL) are to be measured for use of the coupler in reception (Rx). A known test structure typically consists of the 2DGC coupler 41 to be tested, which is arranged at the input, and a coupler 42 identical to said coupler 41 to be tested, which is arranged at the output, as in example (a) shown on the left of the figure. The two couplers are arranged back-to-back, their guided optical terminals (terminals 37 and 38 in FIG. 2) being coupled together by two respective planar waveguides. The fibered optical terminal (terminal 39 in FIG. 2) of the 41 coupler to be tested is configured as an optical input, adapted to receive an optical input signal via an optical input fiber. The fibered optical terminal of the mirrored coupler 42 is configured as an optical output, adapted to deliver an output optical signal via an output optical fiber. Such a test structure was used, for example, in the study work leading to the publication of the scientific paper by S. Plantier et al, “Impact of scattering element shape on polarization dependent loss in two-dimensional grating couplers”, IEEE 13th International Conference on Group IV Photonics (GFP), August 2016, doi: 10.1109/GROUP4.2016.7739057.

In another example (b) of a known test structure shown in the center of FIG. 3, instead of another 2DGC like the coupler 42 of example (a), here another type of silicon/fiber coupler(s) is arranged at the output, for example a coupler 43 and a coupler 44 each in an output branch of the 2DGC coupler to be tested 41. Couplers 43 and 44 can be single-input, single-output 1DGC couplers.

In a third example (c) shown on the right of FIG. 3, photodiodes are arranged directly at the respective outputs of the coupler to be tested 41, which may, for example, be integrated within the test structure on the same silicon substrate.

In all cases, it is the sum of the intensity T1 and of the intensity T2 of the electric fields propagating from the two respective outputs of the 2DGC that must be considered. To this end, in the case of structures (b) and (c) in FIG. 3, a sensor of the transmitted intensity is provided at the output of each of the branches, and the values they measure are summed. PDLs can be measured by any known measuring device, e.g. devices based on reflection or transmission measurement using the Jones matrix method, the Mueller matrix method, and so on.

Referring to the illustration given by the graph in FIG. 4, one method of measuring the PDL of a 2DGC with any of the conventional test structures in FIG. 3, consists in measuring the transmission of this optical component over a specified time interval ΔT, during which it is ensured that all possible polarization states between polarizations s and p are swept. This is the polarization sweeping method described in the scientific paper by F. Van Laere et al. of 2008, cited in the introduction. In the example shown in FIG. 4, ΔT is equal to 60 seconds, and the maximum transmission deviation found is equal to 0.79 decibels (dB).

This method has the advantage that at no time is it necessary to know the state of polarization incident on the device under test. But it also has a number of practical drawbacks, as already mentioned in the introduction. These include:
polarization must be scanned for each wavelength point, which can take minutes per component, and is not compatible with high-volume testing.
Care must be taken to ensure that the injected power does not vary as a function of the polarization state in s and/or p, and of the wavelength 2.

The embodiments of the test structure according to the invention use another approach, based on observation made by the inventors.

FIG. 5A and FIG. 5B illustrate the reciprocal relationship that has been observed and studied by the inventors for a 2DGC-type coupler 50, between the polarization of light at the coupling input 53, on the one hand, and the phase shift between the two outputs 51 and 52, on the other. A monochromatic light wave of specified wavelength λᵢₙ is introduced into input 53, for example via an optical fiber coupled to the coupling network of input 53 of coupler 50.

In the case of FIG. 5A, the incident \vec{E} electric field is fully p-polarized. If the optical power of the incident wave is Tₚ(λᵢₙ), the light waves respectively scattered in respective waveguides to which outputs 51 and 52 are coupled have a transmitted optical power equal to half of Tₚ(λᵢₙ). Stated otherwise, the optical power propagated in each of the coupler's output branches is then equal to Tₚ(λᵢₙ)/2. The phase shift ϕ between these two propagating waves is equal to π (i.e., ϕ=π). Stated otherwise, the incident wave received at input 53 is split into two waves propagated via outputs 51 and 52 with power shared 50/50 and with a relative phase shift ϕ equal to π(ϕ=π).

In the case now shown in FIG. 5B, the incident electric field \vec{E} is fully s-polarized. If the optical power of the incident wave is Tₛ(λᵢₙ), the light waves respectively scattered in respective waveguides to which outputs 51 and 52 are coupled have a transmitted optical power that is always equal to half of Tₛ (λᵢₙ). Stated otherwise, the optical power propagated in each of the coupler's output branches is then equal to Tₛ (λᵢₙ)/2. But here, the phase shift ϕ between these two propagations is equal to zero (i.e., ϕ=0). Stated otherwise, the incident wave received at input 53 is split into two waves propagated via outputs 51 and 52, still with a 50/50 power split, but with a relative phase shift ϕ equal to 0 (ϕ=0), i.e. with no phase shift.

In an intermediate case between those of FIG. 5A and FIG. 5B, in which the incident wave received at input 53 has a mixed p and s polarization, the power of the incident wave is shared unequally between outputs 51 and 52, and with a phase shift between the two light waves thus transmitted that takes a value intermediate between 0 and π.

But what has been observed is not only the continuity of the phenomenon for any mixed s and p polarization state between the purely s and purely p polarization states mentioned above, but also and above all the reciprocity of this phenomenon. Indeed:
if a phase shift ϕ equal to π is forced between outputs 51 and 52, then the input polarization is a fully p polarization;
if a phase shift ϕ equal to 0 is forced between outputs 51 and 52, then the input polarization is a fully s polarization; and, more generally, if a given phase ϕ is imposed between outputs 51 and 52, the value of which lies between 0 and π, then the polarization of the light on input 53 is an intermediate polarization in s and p, and the relationship between said phase and said polarization is a reciprocal one, i.e. it follows a continuous and bijective function.

Put another way, it has been observed that, by reciprocity, modifying the phase relationship between the two output waves of a 2DGC-type silicon-fiber coupler with one input and two outputs, is equivalent to modifying the polarization state of the optical signal on the input. The principle behind the invention is based on the ability to generate a phase shift between the two arms of the test structure shown in FIG. 3, version (a) for example, in order to emulate a polarization sweep of the injected/transmitted optical signal without having to control its polarization.

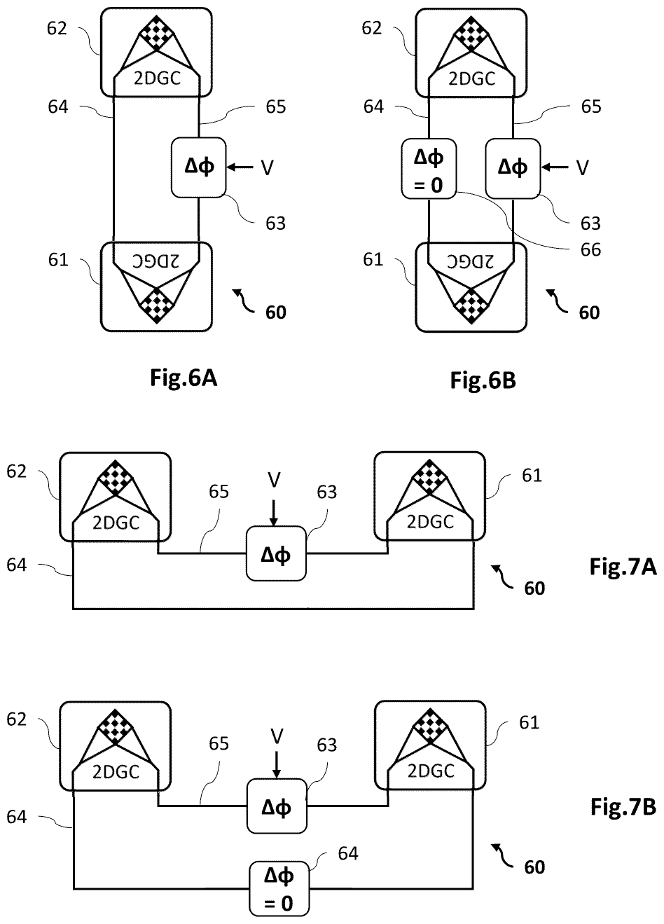

In particular, the test structure 60 shown in FIG. 6A is similar to example (a) in FIG. 3, but is modified to enable measurement of the PDL of the 2DGC under test, circumventing the need to change the polarization of the input light. The fiber optic terminal (terminal 39 in FIG. 2) of the mirrored coupler 62 is configured as an optical input (the coupler 62 mirrored to the coupler under test 61 in the embodiment shown in FIG. 6A is referred to as an input coupler). This input terminal is adapted to receive an optical input signal via an optical input fiber. The fibered optical terminal of test coupler 61 is configured as an optical output, adapted to deliver an optical output signal via an optical output fiber. The guided optical terminals of couplers 61 and 62 are coupled together via planar silicon waveguides 64 and 65.

According to embodiments of the invention, an adjustable phase shifter 63 (or phase modulator) is integrated into a first optical path or arm, between the two identical back-to-back couplers 61 and 62. In the example shown, the phase shifter is arranged in the arm of structure 60 that includes planar waveguide 65 (right-hand arm, in FIG. 6A). This is pure phase modulation, i.e. without intensity modulation (e.g. using a so-called “thermal” phase modulator, which is known for this property). The polarization of the light at the input input coupler 62 can thus be switched between pure s-polarization and pure p-polarization by means of a phase-shift adjustment voltage V that is applied to a phase-shift adjustment input of phase modulator 63, as shown above with reference to FIG. 5A and FIG. 5B. By varying the control voltage V, the phase shift applied to the optical signal propagation in this first arm of the test structure 60 can be made to sweep the range [0;π]. This forces the polarization of the optical signal entering the coupler under test 61 to sweep all mixed states between the fully s-polarized state and the fully p-polarized state, respectively. The polarization-induced transmission difference, and therefore the PDL of the 2DGC, can thus be simply determined.

FIG. 6B shows a variant of the test structure of FIG. 6A in which a phase modulator 66 is introduced into the other arm of the structure, namely that comprising the planar waveguide 64 (left arm in the figure). This other phase modulator 66 is structurally identical to the phase modulator 63 present in the first arm of the test structure 60, namely that comprising the waveguide 65. However, phase modulator 66 is configured in such a way as not to introduce any phase shift for optical signal propagation in waveguide 64. Everything happens as if it were permanently controlled in such a way that the phase shift Δϕ introduced is zero (Δϕ=0). In other words, this is a “dummy” phase modulator, the presence of which nevertheless makes it possible to balance the characteristics of light propagation in the two arms 64 and 65 of the test structure 60. These characteristics include any induced polarization variation, any induced losses, any static phase shift or even any wavelength shift introduced by the phase modulator 63, depending on the technology chosen for this modulator and, where applicable, on the specific features of each application.

The two variants of the test structure shown in FIG. 6A and FIG. 6B, respectively, are suitable for use of the test structure with input and output optical fibers that are opposite each other, i.e. facing each other (in the vertical direction in the schematic views of FIG. 6A and FIG. 6B).

FIG. 7A and FIG. 7B show two further embodiments of a test structure proposed by the invention, which are variants of the test structures of FIG. 6A and FIG. 6B, respectively. The test devices in FIG. 7A and FIG. 7B are adapted for use with respective input and output optical fibers that are arranged side-by-side (in the horizontal direction in the schematic views of FIG. 7A and FIG. 7B) in a unitary block, also known as a fiber array unit. Fiber arrays are one- or two-dimensional arrays of optical fibers. Often, such an array is formed only at the end of a fiber bundle, rather than along the entire length of the fibers in question. The advantage of such a fiber array is generally to enable light from an array of optical sources adjacent to each other to be introduced into the fibers concerned, or to enable separate fibers to be coupled to another component via an array of planar waveguides adjacent to each other on a photonic integrated circuit, as is the case here.

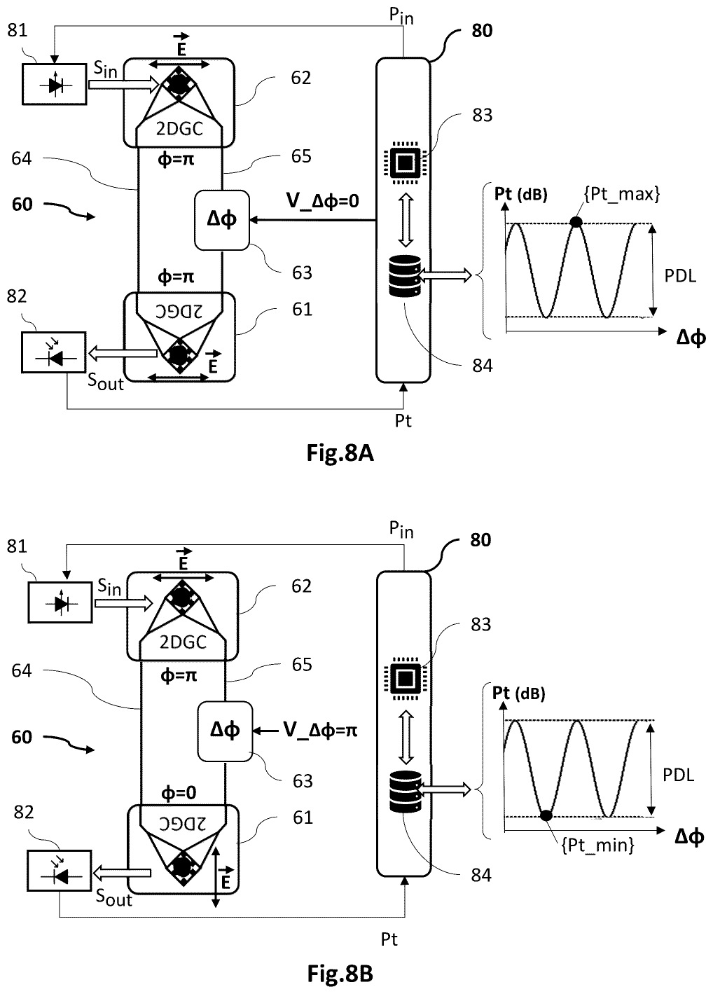

With reference to the diagrams in FIG. 8A and FIG. 8B, it will now be described an example of a method for characterizing the PDL of a 2DGC with the test structure proposed above with reference to the diagrams in FIG. 6A and FIG. 6B, or their variants in FIG. 7A and FIG. 7B, respectively. For the description of this example, particular consideration will be given to the test structure 60 of FIG. 6A, but the skilled person will appreciate that the PDL method of measuring is the same for the other test structures shown with reference to FIG. 6B, FIG. 7A or FIG. 7B.

In one example, a certain number of couplers to be tested are manufactured on the same wafer, for example a series of around a hundred couplers, each in a test device according to embodiments the invention, but with small variations in design and/or manufacturing technology parameters between each of these couplers. The tests make it possible to assess which version(s) of the couplers in the series give the smallest PDL. Such operations are common practice, as such, in the semiconductor industry in order to design high-performance photonic components.

Test equipment includes a test controller 80, at least one polarized light source 81, and a light sensor or photodetector 82 for each of the test structures such as structure 60 shown in FIG. 8A and FIG. 8B which can be tested simultaneously in the same test. The test controller 80 comprises a computer 83, such as a microprocessor, and a memory 84 comprising RAM (Random Access Memory).

The test equipment (or probing station) is used to test unpackaged chips, on which the transmitted power is measured using optical probes respectively associated with each test structure. For example, controller 80 can be coupled to a photodiode 82 at the output of test structure 60 shown in FIG. 8A and FIG. 8B. This photodiode 82 can be integrated into the test structure itself, i.e. it can be formed on the same silicon substrate, to measure the optical power Pt at the output of the coupler under test 61, which is the power transmitted by the test structure 60 from the light power Pᵢₙ injected at the input at the input coupler 62. Alternatively, light can be output from the test structure 60 via an output optical fiber coupled to the coupling grating of the coupler under test 61, in order to measure the light power with an external remote photodiode. In both cases, the photodiode converts the optical signal it receives from the coupler 61 into an electrical signal representative of the light intensity transmitted through the test structure 60. It is this electrical signal that constitutes the measurement of transmitted light power Pt.

In the test controller 80, there is software which, when loaded into memory 84 and executed by processor 83, records the data corresponding to the graphs of the curves shown on the right of FIG. 8A and FIG. 8B, and which is configured to extract the PDL from said recorded data. The PDL is given by the difference between the T_max value and the T_min value of the optical transmission T of the test structure 60. This is determined on the basis of the power Pᵢₙ of the input optical signal Vin, and on the basis of the transmitted power Pt transmitted by the structure under test 60, which is measured during scanning of the range of values [0;π] of the phase shift Δϕ.

The polarized light source 81 can be formed directly on the silicon substrate (wafer) on which the test structures are formed, or it can be a source external to the wafer of the test structures to which it is optically coupled by at least one fiber, usually by a fiber array. For example, source 81 may comprise at least one semiconductor laser, such as a laser diode emitting at at least one wavelength in the spectrum of interest. In embodiments, the laser diode may be adjustable (also known as “tunable”), i.e. the length of the laser's optical cavity may be varied in a controlled manner, enabling them to be continuously tuned over a relatively wide range of wavelengths. For example, a semiconductor laser with Distributed Feedback (DFB), or a Vertical Cavity Surface Emitting Laser (VCSEL), which use periodic Distributed Bragg Reflector (DBR) structures to form the mirrors of the optical cavity. The temperature of the laser can also be modified, since the temperature-related change in the optical index of the DBR structure results in a shift in its wavelength of maximum reflection, and therefore in the laser wavelength. The tuning range of these lasers is typically a few nanometers (nm), up to a maximum of around 6 nm, when the laser temperature is varied over about 50 degrees Kelvin (K). Generally the wavelength is tuned by 0.08 nm/K for DFB lasers operating in the 1550 nm wavelength regime. These lasers are commonly used in optical communications applications such as DWDM (Dense Wavelength Division Multiplexing) systems to enable tuning of the signal wavelength, so that the person skilled in the art will know how to implement them without the need for further guidance here. To achieve even wider-band tuning using this technique, a laser array of this type can be provided on a single chip, and the laser wavelength tuning ranges can be concatenated.

Monochromatic polarized light, produced at a wavelength λᵢₙ determined by polarized light source 81, can be introduced into each of the test structures being tested simultaneously, for example by a bundle of respective optic fibers, or by a fiber array. This ensures that each test structure is excited by light with the same characteristics (incident wavelength(s) λᵢₙ, input light power Pᵢₙ, polarization s or p, phase ϕᵢₙ) as the other test structures. This is not a condition specific to PDL measurement according to modes of implementation according to the invention, but enables comparable PDL measurement results for a plurality of optical couplers that are performed using a plurality of respective test structures. For example, the indicative wavelength λᵢₙ may lie in the so-called “C” and “L” bands from 1450 nm to 1650 nm, for example between 1510 nm and 1590 nm, or in the so-called “O” band between 1270 nm and 1360 nm, depending on the applications envisaged for the optical coupler model under test 61. However, what is described in this particular case also works for other wavelengths.

An example of a method of characterizing the PDL of a 2DGC coupler under test 61 will now be described. Reference is again made to FIG. 8A and FIG. 8B, and to the step diagram in FIG. 10.

In order to excite the coupling network of the input coupler 62 of the test structure 60 of FIG. 8A and FIG. 8B, an incident optical signal Sᵢₙ at wavelength λᵢₙ, polarized p, and having intensity (optical power) Pᵢₙ, is produced by source 81 and inserted at step 101, into the fibered optical terminal of input coupler 62, for example via a polarization-maintaining input optical fiber. The polarization of the incident light can be either fully p-polarized, as in the example shown, or fully s-polarized. For these two incident polarization states, indeed, the two components of the incident optical signal Sᵢₙ propagate with the same intensity in each of the planar silicon waveguides 65 and 64 coupled to the guided optical terminals of the input 2DGC 62. This intensity will be equal to half of Pᵢₙ-Stated otherwise, the input optical signal Sᵢₙ is divided into two components of mutually equal respective intensities, which are each inserted into one of the two arms of the test structure 60 that comprise the planar waveguide 65 and the planar waveguide 64, respectively. It again mentioned that, in the example shown, the polarization of the incident light Sᵢₙ is entirely p (as illustrated by FIG. 5A already described in the foregoing). But there is no difference in the process implemented otherwise, if the polarization of the incident light is entirely s (as illustrated by FIG. 5B also already described).

Then, in step 102, the optical transmission of the 2DGC under test 61 i.e. the transmitted power Pt which is measured at the output of said coupler 61 by the photodetector 82, which is for example a photodiode. More precisely, a series of measurements are carried out while the phase shift Δϕ introduced into the arm of the structure which comprises the planar waveguide 65 by the phase modulator 63 is varied between 0 and π, by varying the phase modulator control voltage V between its extreme values V=V_Δϕ=0 on the one hand, and V=V_Δϕ=π, on the other. This sweep, over the range of values [0;π] of the phase shift Δϕ which is then introduced into the arm 65 of the test structure by the phase modulator 63, is driven by the processor 83 of the test controller 80 through the execution of ad-hoc driver software. The phase shift Δπ between the two arms 64 and 65 varies the output bias state, i.e. at the output coupler 61 of the test structure 60, which is the device under test (DUT), for an unchanged input bias of the test structure 60. The {Pt} values of the power Pt transmitted by the test structure thus measured, are stored in an indexed manner (as a function of the current value of the phase shift Δϕ), in the form, for example, of a table of values (or LUT, from the English “Lookup Table”), in the memory 84 of the test controller 80. This table of values is indexed by the associated values of the phase shift Δϕ.

Once {Pt} measurements of the transmitted power Pt have been acquired for the entire range of values [0;π] of the phase shift Δϕ, i.e. once the values of the control voltage V of the phase modulator 63 have swept the interval [V_Δϕ=0;V_Δϕ=π], the processor 83 determines in step 103 the amplitude of the variation of this transmitted power Pt, from the {Pt} values stored in memory 84. The maximum value {Pt_max} is given by the configuration shown in FIG. 8A in which the phase ϕ at the input of coupler 61 under test is equal to π (as shown by the point on the curve on the right of said figure). The minimum {Pt_min} value is given by the configuration shown in FIG. 8B in which the phase ϕ at the input of coupler 61 under test is equal to 0 (as shown by the point on the curve to the right of said figure). The person skilled in the art will appreciate that between the initial state illustrated by FIG. 8A and corresponding to an output polarization identical to the totally p polarization at the input (with a phase ϕ=π at the input of coupler 61), on the one hand, and the final state illustrated by FIG. 8B and corresponding to an output polarization which is a totally s polarization (with a phase ϕ=0 at the input of coupler 61 for an invariant phase ϕ=π at the input of test device 60), there are mixed polarization states p and s corresponding to each value of the phase shift Δϕ between 0 and π which is introduced by the phase modulator 63 under control of the controller 80 via the control voltage V of the variable phase shifter 63.

The data processing performed by the processor 83 on the {Pt} values acquired and stored in the memory 84 of the controller 80, which are representative of the transmitted power Pt as a function of the phase shift Δϕ, includes the identification of the maximum value {Pt_max} and the identification of the minimum value {Pt_min} of the transmitted optical power Pt. In the example shown in FIG. 8A and FIG. 8B, the maximum value {Pt_max} is obtained for a phase shift between the two arms of test structure 60 that equals zero (Δϕ=0), which corresponds to the configuration in FIG. 8A. Graphically, the value {Pt_max} corresponds to a peak of the curve shown on the right-hand side of FIG. 8A, which gives the shape of the dephasing response of the test structure 60, i.e. the transmitted power Pt as a function of the phase shift Δϕ introduced by the phase modulator 63. Furthermore, the value {Pt_min} graphically corresponds to a dip in the curve shown on the right-hand side of FIG. 8B, which gives the transmitted power Pt as a function of the phase shift Δϕ introduced by the phase modulator 63.

The transmission coefficient of test structure 60 is given by

$$T = \frac{{P}_{t}}{{P}_{in}} .$$

The amplitude Tₘₐₓ−Tₘᵢₙ of the variation in transmission Tis given by the difference between the two extreme values {Pt_max} and {Pt_min}, at a value Pᵢₙ kept constant throughout the test process. This amplitude gives, at step 104, the PDL value of the 2DGC coupler 61 under test, in accordance with equation (2) given above. Stated otherwise, the polarization-related PDL losses of coupler 61 are calculated on the basis of the maximum value {Pt_max} and minimum value {Pt_min} of optical power Pt measured at the output of test structure 60. Advantageously, it will be noted that it is not useful to know the relationship between the control voltage V of the variable phase shifter 63 and the phase shift value Δϕ it generates, since only the difference in light intensity between a peak and a trough is of interest, in order to differentiate between them. Stated otherwise, PDL determination is carried out in differential mode, or relative mode, by simple searches for a maximum and minimum in a table of indexed values, which is a process that can be executed quickly by the processor 83 of the test controller 80.

Those skilled in the art will appreciate that from the measurements {Pt} of the power transmitted in the test structure, which are stored in memory 84, it is also possible to obtain the value of the insertion losses IL of the coupler under test 61. This is common practise in itself. The insertion losses of the coupling network 61 under test can in fact be obtained by halving the transmitted power Pt while the phase modulator is not actuated, i.e. with V=V_Δϕ=0, so that the phase shift Δϕ between the two branches of the test structure 60 is zero. In this configuration, the incoming and outgoing polarizations are the same (namely fully s polarization, in the example shown in the corresponding FIG. 8A). In practice, this is true if the length of the guides between inputs and outputs is less than a few millimeters (mm). Otherwise, small random manufacturing variations mean that the relative phase at the end of the two guides may not be strictly equal to zero

As will be understood, the test process described above for a given monochromatic input light wave can be repeated for other values of wavelength λᵢₙ within a wavelength band of interest, in order to characterize in wavelengths the PDL and IL losses of the coupler 61 under test for said band.

In principle, the {Pt_max} and {Pt_min} values obtained for each wavelength do not vary from one interval [0,π] to the next, so that there is no need, for example, to average the PDL calculation over several successive hollow-peak deviations from the phase-shift response curve of the 60 test structure. The {Pt_max} and/or {Pt_min} values could vary if there were variable losses on the optical paths in test structure 60, which is not the case with the proposed test structure.

In order to avoid an uncontrolled dynamic phase deviation between the two respective arms of test structure 60, which could be introduced by the phase modulator at as a function of the variation in its control voltage V, some embodiments of the test structure may provide for the use of an optical phase shifter with a thermo-optical effect. With such an optical phase shifter, the variation in phase Δϕ is obtained by varying the refractive index of the material forming the core of the waveguide 65 in question, via a change in the temperature applied to said waveguide 65. Advantageously, such a thermo-optical phase shifter does not modify the intensity of the optical signal circulating in said waveguide 65. A possible embodiment of a thermo-optic effect optical phase shifter is described, for example, in the scientific article by Harris N. C. et al, “Efficient, Compact and Low Loss Thermo-Optic Phase Shifter in Silicon”, Optics Express 22 9 (2014), DOI: 10487-93. In addition, a comparison between different examples of thermo-optic optical phase shifters was the subject of the scientific paper by A. Masood et al, “Comparison of heater architectures for thermal control of silicon photonic circuits”, 10th International Conference on Group IV Photonics, Seoul, Korea (South), 2013, pp. 83-84, DOI: 10.1109/Group4.2013.6644437.

For example, in a particular embodiment, the phase shifter 63 may comprise:
a waveguide through which the optical signal to be phase-shifted passes, which is constituted by the planar waveguide 65 of the first arm of the test structure considered here; and,
a resistive metal located close to this planar waveguide 65.

In response to the phase-shift control voltage V supplied by the test controller 80, a potential difference is applied to this resistive metal, generating heat. The resistive metal thus varies the temperature of the waveguide 65 and hence its refractive index. This alters the phase of the optical signal passing through the waveguide.

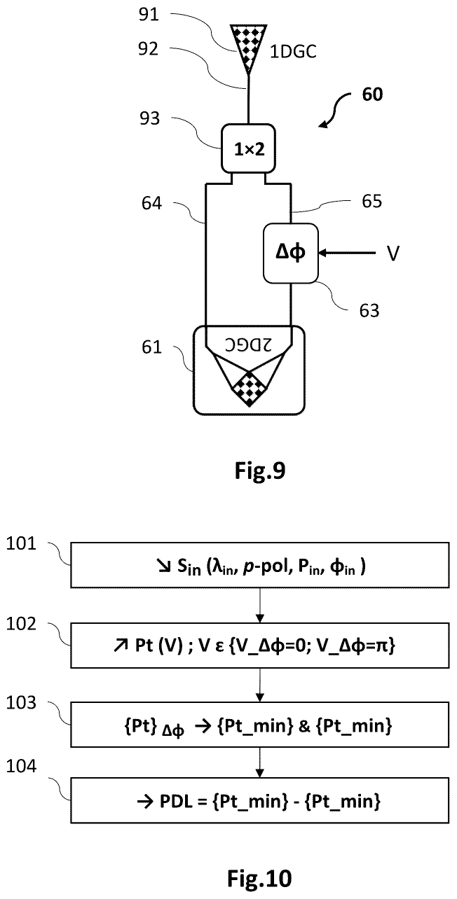

To directly access the 2DGC PDL using the test method described above with reference to FIG. 8A and FIG. 8B, the light intensity of the optical signal flowing in each of the two arms of the test structure (i.e., in each of the two waveguides 64 and 65) must be the same. This condition is satisfied if the incident polarization is strictly symmetrical, which is the case when the incident optical signal is fully s-polarized or fully p-polarized, as provided for in the process implementation modes described above. If this cannot be ensured, however, a variant of the test structure such as that shown in FIG. 9 can be used.

FIG. 9 shows a variant of the test structure comprising, in place of the coupler 62 mirroring the coupler 61 under test, another type of fiber/silicon coupler 91, an on-silicon waveguide 92, and an optical power splitter 93. The fiber/silicon coupler 91 is a “1 to 1” type coupler (i.e., with one fibered input and one silicon-guided output), for example, a one-dimensional grating coupling (1DGC) optical coupler as shown, or an edge coupler. Optical power splitter 93 is a splitter with one input and with two outputs, and with 50/50 splitting of input optical power between said outputs. Thus, the light intensity in waveguide 92 is equally split between its two outputs by optical power splitter 93. The latter can be a “Y”-shaped junction, a multimode interference coupler (MMI “Multi Mode Interference”), or a directional coupler. A first output of the optical power splitter 93 is coupled to the waveguide 64 that forms the first arm of the test structure, while the second output of said splitter 93 is coupled to the waveguide 65 that forms the second arm of said test structure. With this variant, the PDL of the 2DGC can be determined without the need for a known, well-defined input polarization.

The present invention has been described and illustrated in this detailed description and in the figures of the appended drawings, in possible embodiments. The present invention is not, however, limited to the embodiments shown. Other variants and embodiments can be deduced and implemented by the person skilled in the art from the present description and the appended drawings.

In the claims, the term “comprise” or “include” does not exclude other elements or steps. The various features presented and/or claimed may advantageously be combined. Their presence in the description or in different dependent claims does not exclude this possibility. Reference signs are not to be understood as limiting the scope of the invention.

### LIST OF DOCUMENTS CITED

### Patent Documents

US20120207428A1

### Non-Patent Literature

F. Van Laere et al, “Efficient Polarization Diversity Grating Couplers in Bonded InP-Membrane” IEEE Photonics Technol. Lett. vol. 20, no. 4, pp. 318-320, February 2008, DOI: 10.1109/LPT.2007.915587
Mekis et al, “A Grating-Coupler-Enabled CMOS Photonics Platform”, IEEE J. Sel. Top. Quantum Electron, vol. 17, no. 3, pp. 597-608, May 2011, DOI: 10.1109/JSTQE.2010.2086049
S. Plantier et al, “Impact of scattering element shape on polarization dependent loss in two dimensional grating couplers”, IEEE 13th International Conference on Group IV Photonics (GFP), August 2016, DOI: 10.1109/GROUP4.2016.7739057
Harris, N. C., et al, “Efficient, Compact and Low Loss Thermo-Optic Phase Shifter in Silicon”, Optics Express 22 9 (2014), DOI: 10487-93
A. Masood et al, “Comparison of heater architectures for thermal control of silicon photonic circuits”, 10th International Conference on Group IV Photonics, Seoul, Korea (South), 2013, pp. 83-84, DOI: 10.1109/Group4.2013.6644437
Robert HALIR et al. “Reducing Polarization-Dependent Loss of Silicon-on-Insulator Fiber to Chip Grating Couplers”, IEEE PHOTONICS TECHNOLOGY LETTERS, IEEE, USA, vol. 22, no. 6, Mar. 15, 2010 (2010-03-15), pages 389-391, ISSN: 1041-1135, DOI: 10.1109/LPT.2009.2039869
Zanyun ZHANG et al. “High-Efficiency Two-Dimensional Perfectly Vertical Grating Coupler With Ultra-Low Polarization Dependent Loss and Large Fibre Misalignment Tolerance”, IEEE JOURNAL OF QUANTUM ELECTRONICS, IEEE, USA, vol. 57, no. 5, Jul. 7, 2021 (2021-07-07), pages 1-7, ISSN: 0018-9197, DOI: 10.1109/JQE.2021.3095289
Zanyun ZHANG et al, entitled “Two-Dimensional Apodized Grating Coupler for Polarization-Independent and Surface-Normal Optical Coupling”, JOURNAL OF LIGHTWAVE TECHNOLOGY, IEEE, USA, vol. 38, no. 15, Apr. 8, 2020 (2020-04-08), pages 4037-4044, ISSN: 0733-8724, DOI: 10.1109/JLT.2020.2986043

1. An integrated test structure on silicon for the characterization of the polarization-dependent loss, PDL, of a fiber/silicon optical coupler of the “1-to-2” type with a two-dimensional diffraction grating coupler, 2DGC, having a fiber-optic terminal as well as a first guided optical terminal and a second guided optical terminal, said test structure comprising:
a first planar waveguide with two ends;
a second planar waveguide with two ends;
a input fiber/silicon optical coupler having a fiber optic terminal, adapted to receive an input optical signal (Sin) via said fiber optic terminal, and associated optical splitting means which are adapted to split said input optical signal (Sin) into two components of equal respective optical intensities, and which are arranged to insert each of said components into the first planar waveguide and into the second planar waveguide, respectively, at a respective first end of said planar waveguides; and, the 2DGC under test, arranged as an output fiber/silicon optical coupler with its two guided optical terminals coupled to a second end of the first planar waveguide and the second planar waveguide, respectively, and configured to deliver an optical output signal on its fiber-optic terminal,
comprising:
at least one first adjustable phase shifter which is arranged at the first planar waveguide between the input optical coupler and the 2DGC under test, and which is configured to be controlled so as to apply a phase shift determined between 0 and π, as a function of a phase shift adjustment signal (V), to the optical signal propagating in said first planar waveguide, said phase shift being a pure phase shift, i.e. without optical intensity variation.

2. The test structure as claimed in claim 1, wherein the input optical coupler and its associated equally dividing optical splitting means comprise a 1-to-1 fiber/silicon optical coupler followed by an optical power splitter with one input and two outputs and with equal optical power splitting between said outputs, said outputs each being coupled to one of the first ends of the first planar waveguide and the second planar waveguide, respectively.

3. The test structure of claim 2, wherein the optical fiber/silicon 1-to-1 coupler is a one-dimensional diffraction grating coupler, 1DGC.

4. The test structure of claim 1, wherein the input optical coupler and its associated optical splitting means comprise a second 2DGC, identical to the 2DGC under test, and having its guided optical terminals each coupled to the other of the ends of the first planar waveguide and the second planar waveguide, respectively.

5. The test structure according to claim 1, further comprising a second adjustable phase shifter, structurally identical to the first adjustable phase shifter, which is arranged at the level of the second planar waveguide between the input optical coupler and the 2DGC under test, and which is configured so that it permanently applies no phase shift to the optical signal propagating in said second waveguide.

6. The test device according to claim 1, wherein the optical coupler under test and the input optical coupler are arranged symmetrically with respect to one another, in such a way that an input optical fiber can be connected to the fiberized optical terminal of the input optical coupler and an output optical fiber can be connected to the fiberized optical terminal of the optical coupler under test, with said input optical fiber and said output optical fiber extending opposite one another.

7. The test device according to claim 1, wherein the optical coupler under test and the input optical coupler are arranged as a block in such a way that an input optical fiber can be connected to the fiber optic terminal of the input optical coupler and an output optical fiber can be connected to the fiber optic terminal of the optical coupler under test, said input optical fiber and said output optical fiber being optical fibers of the same fiber array.

8. The test device according to claim 1, wherein the first phase modulator is a thermo-optical phase shifter.

9. The test equipment for the characterization of the polarization-dependent loss, PDL, of a “1-to-2” fiber/silicon optical coupler with a two-dimensional diffraction grating, 2DGC, comprising:
a silicon-integrated test structure according to claim 4, with the 2DGC coupler under test arranged as the output fiber/silicon optical coupler of said integrated test structure;
a test controller,
a source of polarized light, configured to produce an incident optical signal being either fully p-polarized or fully s-polarized, and
a light sensor arranged to measure the optical power (Pt) at the output of the coupler under test, which is the optical power transmitted by the test structure from the light power (Pin) fed in at the input coupler of said test structure
wherein the test controller comprises a processor and a memory comprising random access memory, and is configured to:
cause the insertion of the incident optical signal (Sin) produced by the source into the fibered optical terminal of the input optical coupler of the test structure;
drive the adjustable phase shifter of the test structure by varying the phase shift adjustment signal (V) of said phase shifter so that the phase shift applied to the optical signal propagating in the first planar waveguide of said test structure sweeps the interval [0;π]; and at the same time,
cause the light sensor to measure, and the memory to store, values of the optical power (Pt) transmitted through the test structure as a function of the value (Δϕ) of the phase shift,
determine the maximum value (Pt_max) and the minimum value (Pt_min) of the measured and stored values (Pt) of the transmitted optical power; and,
obtain the PDL as the difference between said maximum value (Pt_max) and said minimum value (Pt_min).

10. The test equipment according to claim 9, wherein the polarized light source and/or the light sensor are formed on the same silicon substrate, or wafer, on which the test structure is formed.

11. A method of characterizing the polarization-dependent loss, PDL, of a “1-to-2” fiber/silicon optical coupler with a two-dimensional diffraction grating, 2DGC, using a silicon-integrated test structure according to claim 1, said method comprising the following steps:
inserting an optical input signal (Vin) into the fiber optic terminal of the optical input coupler;
measuring and recording values of the optical power (Pt) transmitted through the test structure as a function of the value (Δϕ) of the phase shift applied to the optical signal propagating in the first planar waveguide by the adjustable phase shifter, while the phase shift adjustment signal (V) of said phase shifter is varied so that said phase shift sweeps the interval [0;π];
determining the maximum value (Pt_max) and the minimum value (Pt_min) of the measured and stored values of the transmitted optical power (Pt); and,
obtaining the PDL as the difference between said maximum value (Pt_max) and said minimum value (Pt_min).

12. A computer program product comprising one or more sequences of instructions stored on a memory medium readable by a machine comprising a pro-cessor, said sequences of instructions being adapted to perform all the steps of the method according to claim 11 when the program is read from the memory medium and executed by the processor.
